(19) United States
(12) Patent Application Publication
(10) Pub. No.: US 2024/0255013 A1
(43) Pub. Date: Aug. 1, 2024

(54) Tolerance Compensation Assembly and Fastening System

(71) Applicant: Illinois Tool Works Inc., Glenview, IL (US)

(72) Inventors: Weibin LIU, Shanghai (CN); Mengli SUN, Shanghai (CN)

(21) Appl. No.: 18/422,766

(22) Filed: Jan. 25, 2024

(30) Foreign Application Priority Data
Jan. 31, 2023 (CN) 202310118877.X
Oct. 27, 2023 (CN) 202311415838.2

(51) Int. Cl. F16B 5/02

(52) U.S. Cl. CPC F16B 5/0233; F16B 5/025

(57) ABSTRACT

The present disclosure provides a tolerance compensation assembly comprising a tolerance compensation element and a spreading means. The tolerance compensation element comprises a body including at least two body segments arranged circumferentially about an axis, defining a channel extending along the axis together and connected to each other in a manner movable with respect to each other to enable the body segments to come together and open with respect to each other. The spreading means is inserted into the channel along an insertion direction and has a receiving path extending along the axis to receive a bolt. The spreading means is able to move in the insertion direction driven by the bolt while the bolt is fastening a first part to a second part, so as to apply a radial force to the body segments to cause them to open by moving radially away from each other.

### RELATED APPLICATIONS

The present application claims the benefit of Chinese Patent Application Nos. CN 202310118877.X, filed Jan. 31, 2023, and CN 202311415838.2, filed Oct. 27, 2023, each titled “Tolerance Compensation Assembly and Fastening System,” the contents of which are hereby incorporated by reference.

### TECHNICAL FIELD

Embodiments of the present disclosure relate generally to a tolerance compensation assembly for fastening a first part to a second part, and a tolerance compensation fastening system including the tolerance compensation assembly.

### BACKGROUND

A fastening system with a tolerance compensation function can compensate for manufacturing and installation tolerances while fastening two parts. Such a fastening system is usually threadedly connected to one of the two parts (e.g. a first part) via a tolerance compensation element, such that the tolerance compensation element can be moved in the longitudinal direction relative to the first part to compensate for the tolerance between the two parts in the longitudinal direction.

### SUMMARY OF THE DISCLOSURE

The present disclosure relates generally to a tolerance compensation assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a tolerance compensation assembly according to an embodiment of the present disclosure.

FIG. 1B is a perspective view of an isolation element of the tolerance compensation assembly shown in FIG. 1A.

FIG. 1C is a perspective view of a tolerance compensation element of the tolerance compensation assembly shown in FIG. 1A.

FIG. 1D is an axial cross-sectional view of the tolerance compensation assembly shown in FIG. 1A.

FIG. 2A is a perspective view of a fastening system including the tolerance compensation assembly shown in FIG. 1A in a use state.

FIG. 2B is an exploded view of the fastening system shown in FIG. 2A.

FIG. 3A is an axial cross-sectional view of the fastening system shown in FIG. 2A when a bolt is not tightened.

FIG. 3B is an axial cross-sectional view of the fastening system shown in FIG. 2A when the bolt is tightened.

FIG. 4A is a perspective view of a tolerance compensation assembly according to another embodiment of the present disclosure.

FIG. 4B is an exploded view of the tolerance compensation assembly shown in FIG. 4A.

FIG. 4C is a perspective view of a tolerance compensation element of the tolerance compensation assembly shown in FIG. 4A.

FIG. 4D is an axial cross-sectional view of the tolerance compensation assembly shown in FIG. 4A.

FIG. 5A is an axial cross-sectional view of a fastening system including the tolerance compensation assembly shown in FIG. 4A when a bolt is tightened.

FIG. 5B is an axial cross-sectional view of a fastening system including the tolerance compensation assembly shown in FIG. 4A when the bolt is tightened.

### DETAILED DESCRIPTION OF EMBODIMENTS

Various specific implementations of the present disclosure will be described below with reference to the accompanying drawings which form a part of this description. It should be understood that although the terms indicating directions, such as “front”, “rear”, “upper”, “lower”, “left”, “right”, “top”, and “bottom” are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be arranged in different orientations, these terms indicating directions are merely illustrative and should not be considered as limitations.

Embodiments of the present disclosure provide a tolerance compensation assembly for cooperating with a bolt to fasten a first part (e.g., a flush door handle module of a vehicle) to a second part (e.g., a vehicle door). The tolerance compensation assembly also has a tolerance compensation function and thus can compensate for tolerances caused by the manufacturing and mounting of the parts. The tolerance compensation assembly according to the embodiments of the present disclosure can eliminate the influence of a gap between a threaded connection portion of a tolerance compensation element and a mating threaded connection portion of the first part, so that the two at least partially abut or tightly abut against each other, and it is thus possible to prevent the tolerance compensation element and the first part from shaking relative to each other in a fastening state of the bolt.

According to a first aspect of the present disclosure, the present disclosure provides a tolerance compensation assembly for fastening a first part to a second part using a bolt. The tolerance compensation assembly includes a tolerance compensation element and a spreading means. The tolerance compensation element includes a body and has an axis. The body includes at least two body segments arranged circumferentially about the axis, the at least two body segments together defining a channel extending along the axis and being connected to each other in a manner that is movable with respect to each other so as to enable the at least two body segments to be brought together and opened with respect to each other. The body further includes a threaded connection portion provided on its outer surface for threaded connection with the first part. The spreading means is inserted into the channel along an insertion direction and has a receiving path extending along the axis to receive the bolt. The spreading means is configured to be able to move in the insertion direction driven by the bolt while the bolt is fastening the first part to the second part, so as to apply a radial force to the at least two body segments to cause the at least two body segments to open by moving radially away from each other.

In the tolerance compensation assembly according to the first aspect described above, the spreading means includes a spreading inclined surface. The spreading inclined surface extends at an angle toward the axis in the insertion direction. The tolerance compensation element is provided with a mating inclined surface on the inner wall of the body thereof, and the spreading inclined surface slidably engages with the mating inclined surface to cause the at least two body segments to open by moving radially away from each other.

In the tolerance compensation assembly according to the first aspect described above, the adjacent body segments are connected to each other through elastic elements.

In the tolerance compensation assembly according to the first aspect described above, the spreading means includes an annular spreading ring, and the outer surface of the spreading ring forms the spreading inclined surface. The spreading inclined surface slidably engages with the mating inclined surface when the spreading ring is driven by the bolt to move in the channel, thereby causing the at least two body segments to move radially away from each other.

In the tolerance compensation assembly according to the first aspect described above, the tolerance compensation element is provided with a plurality of ridges that are spaced apart from one another on the inner wall of the body thereof. Each of the ridges has an inclined ridge surface. The ridge surfaces of the plurality of ridges together form the mating inclined surface. A receiving groove is formed between adjacent ridges. The spreading ring further includes a plurality of guiding ribs that are spaced apart from one another on the spreading inclined surface. The plurality of guiding ribs are spaced apart from one another, and are respectively accommodated in the plurality of receiving grooves. The guiding ribs are configured to cooperate with the inner wall of the body to maintain the spreading inclined surface in a centered position within the channel.

The tolerance compensation assembly according to the first aspect described above further includes an isolation element. The isolation element is inserted into the receiving path of the spreading ring and configured to receive the bolt. The isolation element is configured to isolate the tolerance compensation element from the axial fastening force applied by the bolt.

The tolerance compensation assembly according to the first aspect described above further includes at least three elastic legs. The at least three elastic legs are connected to the inner wall of the body and extend into the channel. The at least three elastic legs are configured to retain the isolation element in a centered position in the channel.

In the tolerance compensation assembly according to the first aspect described above, the at least three elastic legs are provided in the receiving grooves.

In the tolerance compensation assembly according to the first aspect described above, each of the elastic legs has a proximal end connected to the body and a distal end forming a free end. The distal end of the elastic leg is provided with an arc-shaped retaining surface. The arc-shaped retaining surface is configured to engage with the isolation element.

The tolerance compensation assembly according to the first aspect described above further includes an annular gasket. The isolation element includes a head flange. The gasket is arranged between the head flange of the isolation element and the spreading ring. The outer diameter of the head flange is greater than the inner diameter of the gasket and smaller than the outer diameter of the gasket.

The tolerance compensation assembly according to the first aspect described above further includes an isolation element. The isolation element is inserted into the channel along the insertion direction, the spreading means is formed by the isolation element, the isolation element forms the receiving path, and the outer surface of the isolation element forms the spreading inclined surface.

In the tolerance compensation assembly according to the first aspect described above, the isolation element is cylindrical. The isolation element includes an operating section, a connecting section, and an extension section connected in turn in the insertion direction thereof. The connecting section forms the spreading means, and the outer surface of the connecting section forms the spreading inclined surface. The body is cylindrical, which includes a receiving section, a transition section, and a guide section connected in turn in the insertion direction of the isolation element. The inner wall of the transition section forms the mating inclined surface. When the body is not opened by the spreading means, the inner diameter of the guide section is smaller than the outer diameter of the operating section and greater than the outer diameter of the extension section.

According to a second aspect of the present disclosure, the present disclosure provides a fastening system for fastening a first part to a second part. The fastening system includes a bolt, and the tolerance compensation assembly according to the first aspect described above. The threaded connection portion on the body of the tolerance compensation element of the tolerance compensation assembly is threadedly connected with the first part. The bolt is inserted into the receiving path of the spreading means and into the second part.

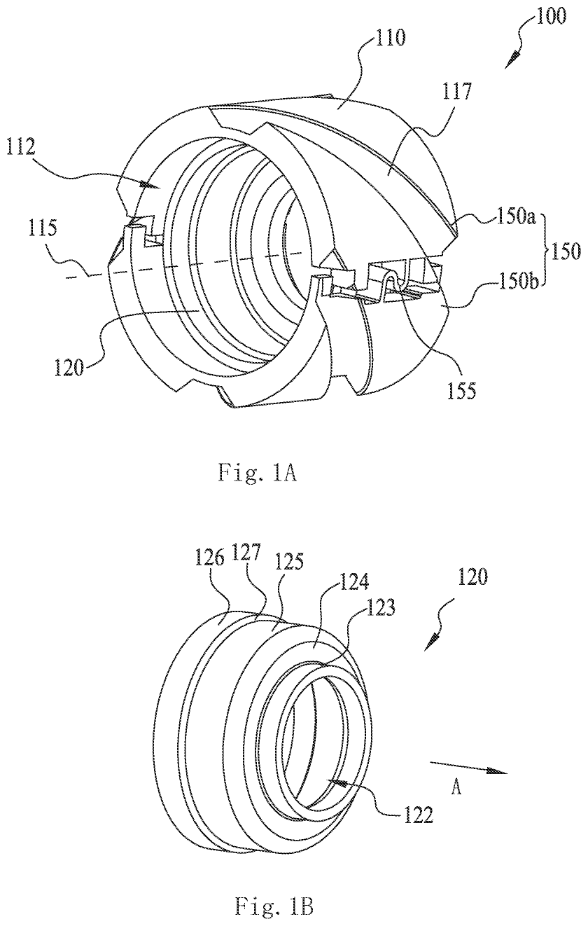

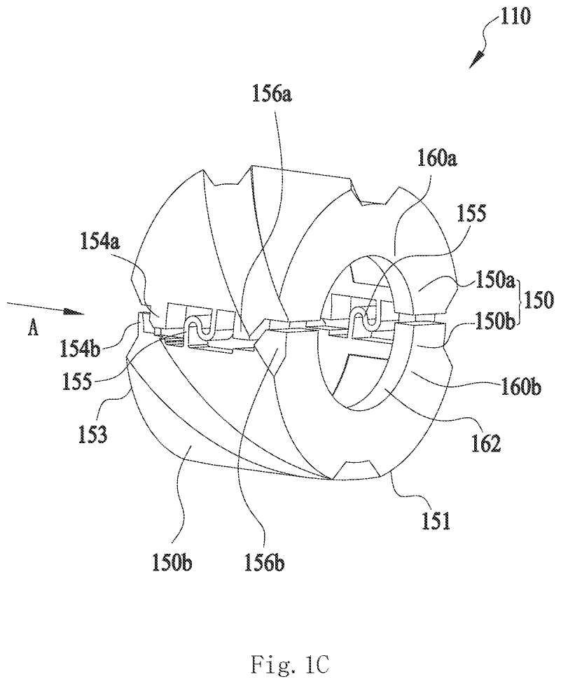

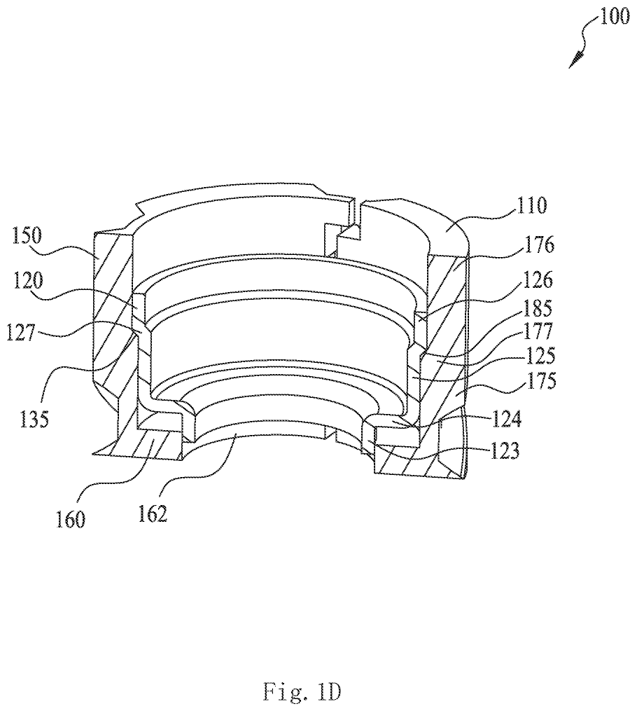

FIGS. 1A-1D show the specific structure of a tolerance compensation assembly 100 according to an embodiment of the present disclosure. FIG. 1A is a perspective view of the tolerance compensation assembly 100, FIG. 1B is a perspective view of an isolation element of the tolerance compensation assembly 100, FIG. 1C is a perspective view of a tolerance compensation element of the tolerance compensation assembly 100, and FIG. 1D is an axial cross-sectional view of the tolerance compensation assembly 100 shown in FIG. 1A.

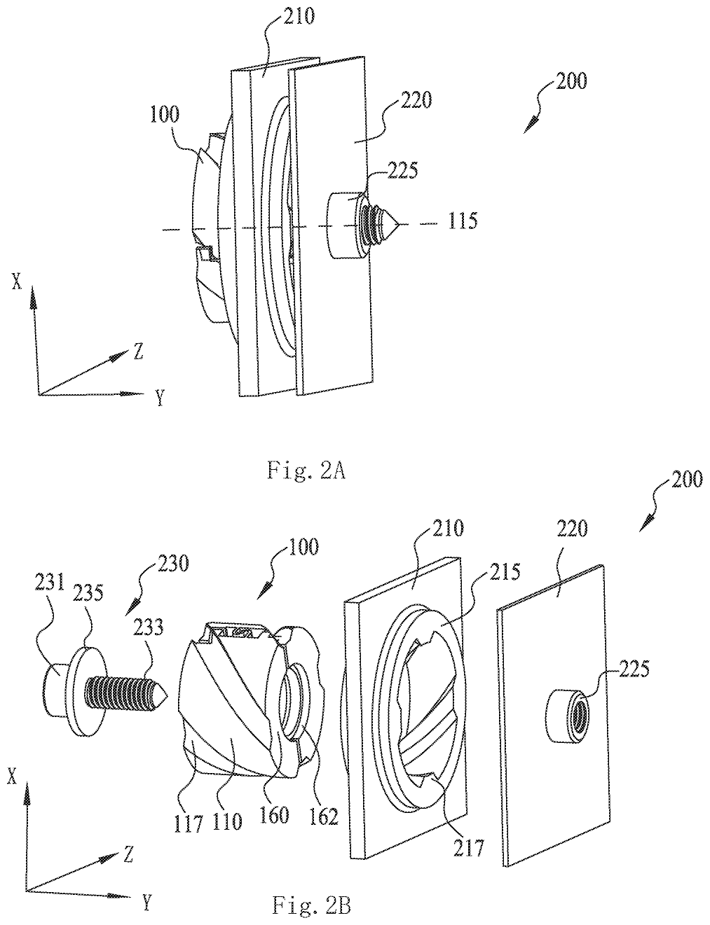

As shown in FIG. 1A, the tolerance compensation assembly 100 includes a tolerance compensation element 110 and an isolation element 120. The isolation element 120 is accommodated in the tolerance compensation element 110. The tolerance compensation assembly 100 is used to fasten a first part (the first part 210 shown in FIG. 2B) to a second part (the second part 220 shown in FIG. 2B) by means of a bolt (the bolt 230 shown in FIG. 2B). The tolerance compensation element 110 is integrally made of plastic material, for example, by injection molding, while the isolation element 120 is made of a metal material. The tolerance compensation element 110 is connected to the first part. The isolation element 120 can isolate the tolerance compensation element 110 from the axial fastening force applied by the bolt, so as to increase the service life of the tolerance compensation element made of plastic.

Still as shown in FIG. 1A, the tolerance compensation element 110 includes a body 150 and has an axis 115. The body 150 is provided with a threaded connection portion 117 on the outer surface thereof for threaded connection with the first part. The body 150 defines a channel 112 extending along the axis 115, and the isolation element 120 is received in the channel 112. The body 150 is generally cylindrical. The body 150 includes two body segments 150a, 150b arranged circumferentially about the axis 115. The two body segments 150a, 150b are hollow semi-cylindrical and together define the channel 112. The two body segments 150a, 150b are connected to each other through elastic elements 155, that is, two opposite ends of the body segment 150a in the circumferential direction are respectively connected to two opposite ends of the other body segment 150b in the circumferential direction through the elastic elements 155. This enables radial movement of the two body segments 150a, 150b relative to each other. Each elastic element 155 is formed from a flexible strip capable of bending and stretching to enable the radial movement of the two body segments 150 relative to each other. That is to say, the two body segments 150 can come together and open with respect to each other. Therefore, the body 150 has at least two states, namely a closed state and an open state. When the body 150 is subjected to no radial force, the body 150 is in the closed state. In this case, the elastic elements 155 are curved, to pull the two body segments 150a, 150b toward each other and bring them together. When the body 150 is subjected to an outward radial force, the body 150 is in the open state, the two body segments 150a, 150b are pushed apart relative to each other, and the elastic elements 155 are stretched.

In order to cause the body segments 150a, 150b to open with respect to each other, the tolerance compensation element of the present disclosure further includes a spreading means. The spreading means is inserted into the channel 112 along an insertion direction (i.e., along the insertion direction indicated by arrow A) and has a receiving path extending along the axis 115 to receive the bolt 230. The spreading means can move in the insertion direction A driven by the bolt 230 while the bolt 230 is fastening the first part 210 to the second part 220, so as to apply a radial force to the two body segments 150a, 150b to cause the two body segments 150a, 150b to open by moving radially away from each other. The spreading means may be configured in a variety of ways. In the embodiment shown in FIGS. 1A-1C, the spreading means is formed by the isolation element 120.

As shown in FIG. 1B, the isolation element 120 is generally cylindrical and defines a receiving path 122 extending along the axis 115. The isolation element 120 includes a neck section 123, a step section 124, an extension section 125, a connecting section 127 and an operating section 126 that are connected in turn in the opposite direction of the insertion direction A. The outer diameter of the neck section 123 is smaller than the outer diameter of the extension section 125, and the two are connected to each other via the step section 124. The outer diameter of the operating section 126 is greater than the outer diameter of the extension section 125, and the two are connected to each other via the connecting section 127. The connecting section 127 has an outer surface that is inclined relative to the axis 115. The connecting section 127 is used to form the spreading means, which applies an outward radial force to the two body segments 150a, 150b of the body 150 while the bolt 230 is fastening the first part 210 and the second part 220, to cause the two body segments 150a, 150b to open away from each other. The outer surface of the connecting section 127 forms a spreading inclined surface 135. The spreading inclined surface 135 is inclined toward the axis 115 in the insertion direction A of the isolation element 120.

As shown in FIG. 1C, the body 150 of the tolerance compensation element 110 includes a proximal end 151 and a distal end 153 opposite to each other. In the insertion direction A, the proximal end 151 is in front of the distal end 153. The tolerance compensation element 110 further includes a flange 160 provided at the proximal end 151 of the body 150. The flange 160 includes two flange segments 160a, 160b provided on the two body segments 150a, 150b respectively. When the two body segments 150a, 150b move radially relative to each other, the two flange segments 160a, 160b move with them. The two flange segments 160a, 160b respectively extend inwardly toward the axis 115 from the two body segments 150a, 150b such that the flange 160 and the body 150 form a generally cup-shaped tolerance compensation element 110 (see FIG. 1D). The flange 160 defines a hole 162 for receiving the bolt, and the diameter of the hole 162 is greater than the diameter of a shaft of the bolt to allow movement of the shaft of the bolt within the hole 162.

Still as shown in FIG. 1C, the two body segments 150a, 150b are respectively provided with structures for preventing the two body segments from moving axially relative to each other. As an example, FIG. 1C shows a pair of upstream projections 154a, 154b and a pair of downstream projections 156a, 156b for this purpose. The pair of upstream projections 156a, 156b are respectively provided on the two body segments 150a, 150b, and are close to the distal end 153. The pair of downstream projections 154a, 154b are respectively provided on the two body segments 150a, 150b, and are close to the proximal end 151. When the tolerance compensation element 110 is in use, since the tolerance compensation element 110 is threadedly connected to the first part 210, the first part 210 can also limit the axial movement of the two body segments 150a, 150b relative to each other.

As shown in FIG. 1D, the body 150 of the tolerance compensation element 110 forms a generally cylindrical inner surface, and includes a guide section 175 with a smaller inner diameter, a receiving section 176 with a greater inner diameter, and a transition section 177 connecting the guide section 175 to the receiving section 176. The inner wall of the transition section 177 forms a mating inclined surface 185. The mating inclined surface 185 connects the inner wall of the guide section 175 to the inner wall of the receiving section 176. The mating inclined surface 185 extends obliquely relative to the axis 115, and the inclination direction thereof is the same as the inclination direction of the spreading inclined surface 135 of the isolation element 120. In the closed state of the body 150, the inner diameter of the guide section 175 of the body 150 is slightly greater than the outer diameter of the extension section 125 of the isolation element 120 to accommodate the extension section 125, but smaller than the outer diameter of the operating section 126 of the isolation element 120, while the inner diameter of the receiving section 176 of the body 150 is slightly greater than the outer diameter of the operating section 126 of the isolation element 120 to accommodate the operating section 126.

Still as shown in FIG. 1C, when the isolation element 120 is inserted into the channel 112 of the tolerance compensation element 110, the neck section 123 of the isolation element 120 can be inserted into the hole 162 of the tolerance compensation element 110, and the step section 124 of the isolation element 120 is blocked by the flange 160.

FIGS. 2A and 2B show the overall structure of a fastening system 200 including the tolerance compensation assembly 100 shown in FIGS. 1A-1C, among which FIG. 2A is a perspective view of the fastening system 200 in use, and FIG. 2B is an exploded view of the fastening system 200.

As shown in FIGS. 2A and 2B, fastening system 200 is used to fasten a first part 210 to a second part 220. In FIGS. 2A and 2B, the first part 210 and the second part 220 are shown in a simplified manner. The fastening system 200 includes the tolerance compensation assembly 100, a bolt 230 for fastening, a nut means 225 provided on the second part 220, and a sleeve 215 provided on the first part 210. The sleeve 215 may be integrally formed with the first part 210, or may be fixed in a hole of the first part 210 through other connection methods. The sleeve 215 is provided with a threaded connection portion 217 on the inner wall thereof for engaging with the threaded connection portion 117 of the tolerance compensation element 110. The bolt 230 passes through the tolerance compensation assembly 100 and engages with the nut means 225 on the second part 220 to fasten the first part 210 and the second part 220 together. Since the tolerance compensation element 110 threadedly engages with the sleeve 215 on the first part 210, the tolerance compensation element 110 can move relative to the first part 210 in a longitudinal direction Y (i.e., the direction of the axis 115), thereby being able to compensate for the tolerance between the first part 210 and the second part 220 in longitudinal direction Y.

In the embodiment shown in the figures, the threaded connection portion 217 of the sleeve 215 is a protruding helical tooth, the threaded connection portion 117 of the tolerance compensation element 110 is a recessed helical groove, and the two engage with each other. In other embodiments, it is also possible that the threaded connection portion 217 of the sleeve 215 is configured as a recessed helical groove, and the threaded connection portion 117 of the tolerance compensation element 110 is configured as a protruding helical tooth.

As shown in FIG. 2B, the bolt 230 includes a head 231 and a shaft 233. The fastening system 200 further includes a spacer 235 for blocking the head 231 of the bolt from entering the hole 162 of the tolerance compensation element 110. Of course, the fastening system 200 may not include the spacer 235, but the radial size of the head 231 is configured to be greater than the radial size of the hole 162, so that the head 231 cannot enter the hole 162 of the tolerance compensation element 110. The radial size of the shaft 233 is configured to be smaller than that of the hole 162 such that the shaft 233 can move in the hole 162 in X, Z directions perpendicular to the longitudinal direction Y, thereby being able to compensate for the tolerances between the first part 210 and the second part 220 in the X, Z directions perpendicular to the longitudinal direction Y.

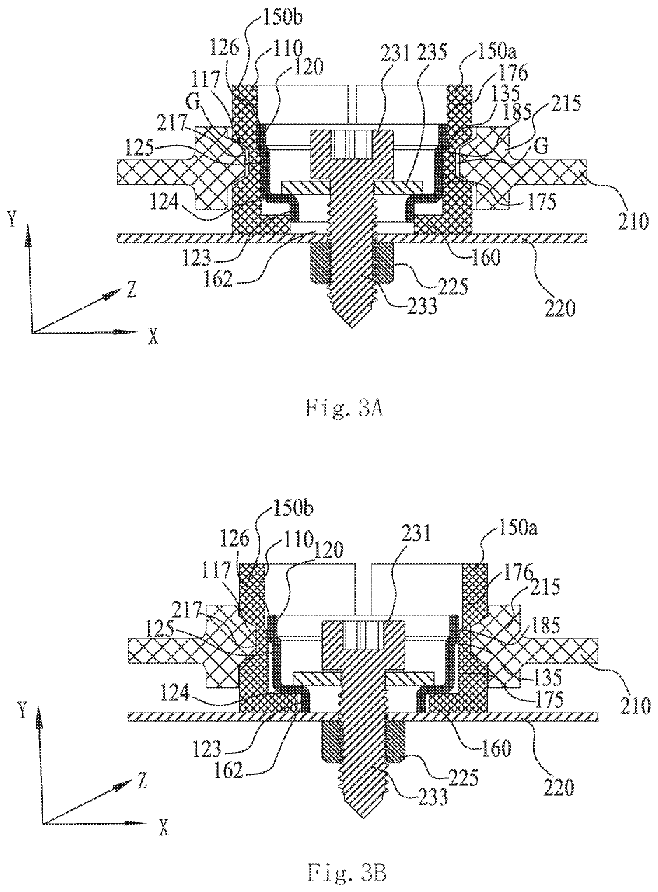

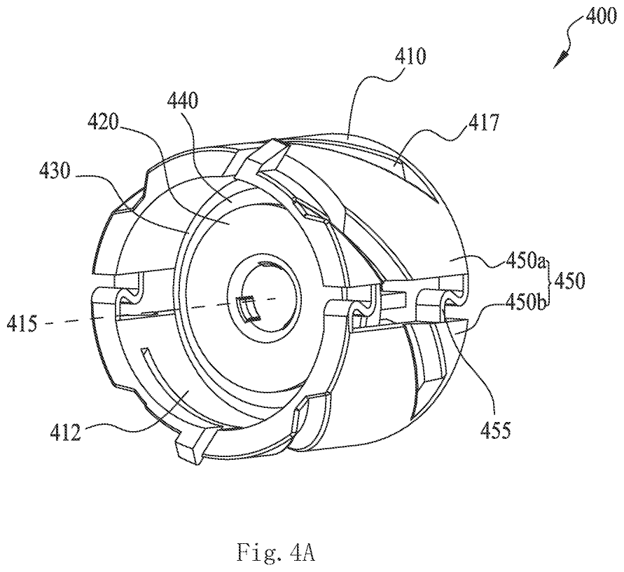

FIGS. 3A and 3B show axial cross-sectional views of the fastening system 200 with the bolt 230 being not tightened and being tightened, respectively.

As shown in FIG. 3A, when the bolt 230 is not tightened, the body 150 of the tolerance compensation element 110 is in the closed state, and the head 231 of the bolt 230 has not applied sufficient axial force to the step section 124 of the isolation element 120, and the neck section 123 of the isolation element 120 has just begun to enter the hole 162 of the tolerance compensation element 110. The operating section 126 and the extension section 125 of the isolation element 120 are respectively in the receiving section 176 and the guide section 175 of the tolerance compensation element 110. The inclined outer surface of the connecting section 127 of the isolation element 120 rests against the guide surface 185 of the tolerance compensation element 110. In the state shown in FIG. 3A, the isolation element 120 has not applied an outward radial force to the body 150 of the tolerance compensation element 110, there is a gap G between the threaded connection portion 117 of the tolerance compensation element 110 and the threaded connection portion 217 of the sleeve 215 on the first part 210, and the threaded connection portion 117 of the tolerance compensation element 110 does not abut against the threaded connection portion 217 of the sleeve 215 on the first part 210. In the state shown in FIG. 3A, the tolerance compensation element 110 has completed the tolerance compensation in the Y direction, and the tolerance compensation element 110 abuts against the second part 220.

During the tightening of the bolt 230, the head 231 of the bolt 230 applies sufficient axial force to the step section 124 of the isolation element 120, such that the spreading inclined surface 135 of the isolation element 120 slidably engages with the mating inclined surface 185 of the tolerance compensation element 110, and the operating section 126 of the isolation element 120 gradually enters the guide section 175 of the body 150 of the tolerance compensation element 110 until the step section 124 of the isolation element 120 abuts against the flange 160 of the tolerance compensation element. During the slidable engagement between the spreading inclined surface 135 of the isolation element 120 and the mating inclined surface 185 of the tolerance compensation element 110, the isolation element 120 applies a radial force to the body 150 to cause the two body segments 150a, 150b of the body 150 to open by moving radially away from each other. The two body segments 150a, 150b of the body 150 cannot move axially relative to each other due to their threaded engagement with the first part 210. In addition, after the operating section 126 of the isolation element 120 enters the guide section 175 of the tolerance compensation element 110, the operating section 126 can keep the body 150 in the open state because the outer diameter of the operating section 126 is greater than the inner diameter of the guide section 175 when the body 150 is in the closed state. From the closed state to the open state of the body 150, the gap G between the threaded connection portion 117 of the tolerance compensation element 110 and the threaded connection portion 217 of the sleeve 215 on the first part 210 is gradually eliminated, because during the movement of the two body segments 150a, 150b radially away from each other, the size of the sleeve 215 on the first part 210 is constant, so that the radial movement of the two body segments 150a, 150b enables the threaded connection portion 117 of the tolerance compensation element 110 and the threaded connection portion 217 of the sleeve 215 on the first part 210 to tightly abut or abut against each other, thereby eliminating at least part of the gap G (as shown in FIG. 3B), and thus there is no relative shaking between the tolerance compensation element 110 and the first part 210. If the body 150 cannot be opened as provided in the embodiments of the present disclosure, then even if the head 231 of the bolt 230 pushes the isolation element 120 to move to the tightened state of the bolt 230, the threaded connection portion 117 of the tolerance compensation element 110 cannot tightly abut against the threaded connection portion 217 of the sleeve 215 on the first part 210, so that the above gap G exists.

As shown in FIG. 3B, when the bolt 230 is tightened, the first part 210 is fastened to the second part 220, and the neck section 123 of the isolation element 120 abuts against the second part 220, so that the axial force applied by the head 231 of the bolt 230 is mainly borne by the isolation element 120 instead of the tolerance compensation element 110 made of plastic. Therefore, the isolation element 120 can reduce the axial fastening force applied by the fastening bolt to the tolerance compensation element 110, so as to prolong the service life of the tolerance compensation element made of plastic.

It should be noted that although in the above embodiments, the body 150 of the compensation unit 110 has two body segments, in other embodiments, the body 150 may have more than two body segments. The adjacent body segments are connected to each other in a manner that is radially movable with respect to each other, and the body segments together form a hollow cylindrical body. In addition, although in the above embodiments, the body 150 is provided with a receiving section 176 with a greater inner diameter, in other embodiments, such a receiving section 176 may not be provided, which is within the scope of the present disclosure.

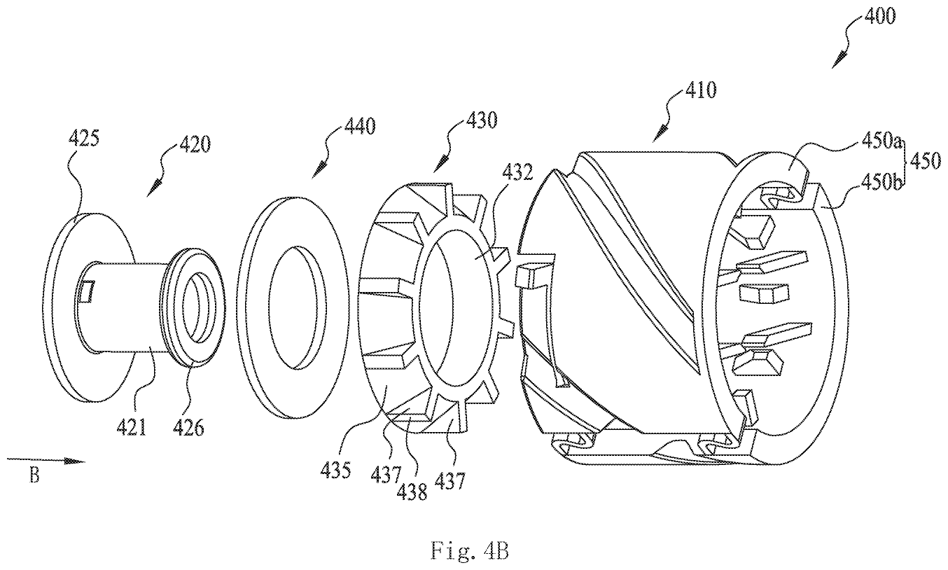

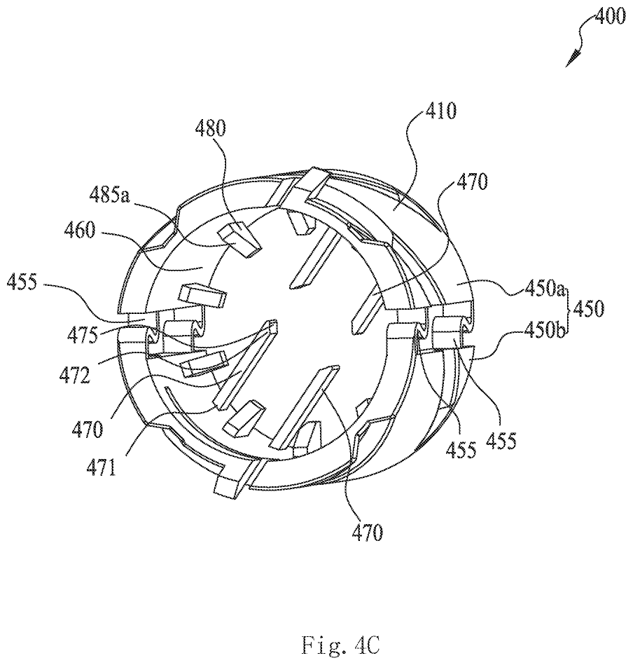

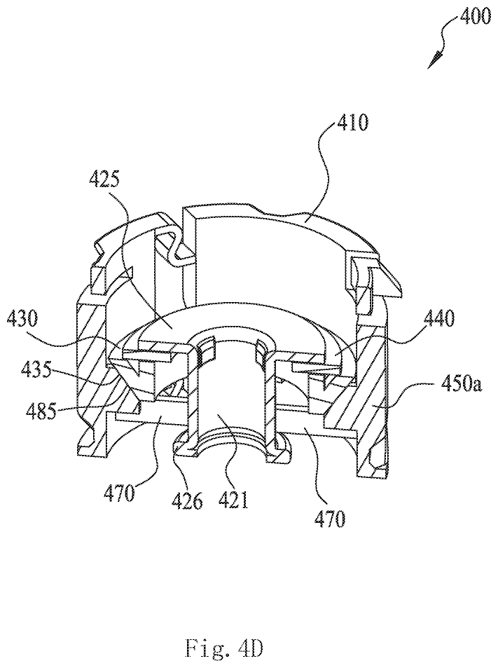

FIGS. 4A-4D show the specific structure of a tolerance compensation assembly 400 according to another embodiment of the present disclosure. FIG. 4A is a perspective view of a tolerance compensation assembly 400, FIG. 4B is an exploded view of the tolerance compensation assembly 400, FIG. 4C is a perspective view of a tolerance compensation element 410 of the tolerance compensation assembly 400, and FIG. 4D is an axial cross-sectional view of the tolerance compensation assembly 400. The tolerance compensation assembly 400 of the embodiment shown in FIGS. 4A-4D is similar to the tolerance compensation assembly 100 of the embodiment shown in FIGS. 1A-1C, in both cases a spreading means is used to spread the body segments of the tolerance compensation element radially relative to each other. The difference is that the spreading means in the two embodiments are configured in different ways. As previously mentioned, in the embodiment shown in FIGS. 1A-1C, the spreading means is formed by the isolation element 120, while in the embodiment shown in FIGS. 4A-4D, the spreading means is formed by a spreading ring separate from the isolation element.

Specifically, as shown in FIGS. 4A and 4B, the tolerance compensation assembly 400 includes a tolerance compensation element 410, an isolation element 420, a spreading ring 430 and an annular spacer 440. The tolerance compensation element 410 and the spreading ring 430 are made of plastic material, for example by injection molding, and the isolation element 420 and the annular spacer 440 are made of metal materials.

As shown in FIGS. 4A-4C, the tolerance compensation element 410 includes a body 450 and has an axis 415. The body 450 is provided with a threaded connection portion 417 on the outer surface thereof. The body 450 defines a channel 412 extending along the axis 415, and the spreading ring 430 is inserted into the channel 412. The body 450 includes two body segments 450a, 450b arranged circumferentially about the axis 415. The two body segments 450a, 450b together define the channel 412. The two body segments 450a, 450b are connected to each other through elastic elements 455, such that the two body segments 450a, 450b can move radially relative to each other, and the tolerance compensation element can thus be opened and closed. Each elastic element 455 is formed from a flexible strip capable of bending and stretching to enable the radial movement of the two body segments 450a, 450b relative to each other. Therefore, the body 450 has at least two states, namely a closed state and an open state. When the body 450 is subjected to no radial force, the body 450 is in the closed state. In this case, the elastic elements 455 are curved to pull the two body segments 450a, 450b toward each other and bring them together. When the body 450 is subjected to an outward radial force, the body 450 is in the open state, the two body segments 450a, 450b are pushed apart relative to each other, and the elastic elements 455 are stretched.

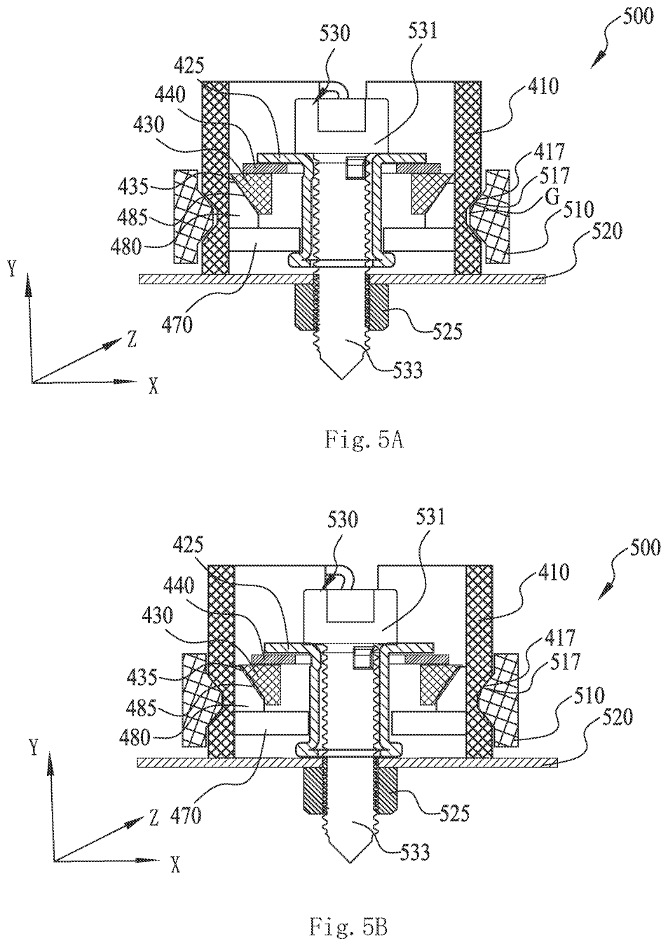

As shown in FIG. 4B, the spreading ring 430 is generally annular and has a spreading inclined surface 435 inclined relative to the axis 415 on its outer surface. The spreading inclined surface 435 is gradually inclined toward the axis 415 in the insertion direction B. The spreading ring 430 also has a number of guiding ribs 437 provided on the spreading inclined surface 435, and the number of guiding ribs 437 are spaced apart from one another in the circumferential direction. The guiding ribs 437 protrude from the spreading inclined surface 435, are generally triangular in shape, and include guide surfaces 438 extending parallel to the axis 415. The guide surfaces 438 of the guiding ribs 437 cooperate with the inner wall of the body 450 to retain the spreading inclined surface 435 in a centered position within the channel 412. The spreading ring 430 defines a receiving path 432 extending along the axis 415 for receiving the isolation element 420, and the isolation element 420 is used to receive a bolt (bolt 530 shown in FIG. 5A). The spreading ring 430 is configured to be able to move in the insertion direction B driven by the bolt 530 while the bolt is fastening the first part to the second part (the first part 510 and the second part 520 shown in FIG. 5A), so as to apply a radial force to the two body segments 450a, 450b to cause the two body segments 450a, 450b to open by moving radially away from each other.

As shown in FIGS. 4C and 4D, the tolerance compensation element 410 further includes a plurality of ridges 480 provided on the inner wall of the body 450. Each ridge 480 is provided with an inclined ridge surface 485a. The ridge surfaces 485a of the plurality of ridges 480 together form a mating inclined surface 485. The mating inclined surface 485 is used to mate with the spreading inclined surface 435, such that the spreading inclined surface 435 slidably engages with the mating inclined surface 485 when the spreading ring 430 is driven by the bolt 530 to move in the channel 412, thereby causing the two body segments 450a, 450b to move radially away from each other. A receiving groove 460 is formed between adjacent ridges 480 for receiving the respective guiding rib 437 on the spreading ring 430.

As shown in FIGS. 4B and 4D, the isolation element 420 is inserted into the channel 412 of the tolerance compensation element 410 along the insertion direction indicated by arrow B. The isolation element 420 includes a hollow cylindrical body portion 421, a head flange 425 provided at a head end of the body portion 421, and a tail flange 426 provided at a tail end of the body portion 421. The bolt 530 passes through the body portion 421, the head flange 425 and the tail flange 426 of the isolation element 420. The annular spacer 440 is arranged between the head flange 425 and the spreading ring 430. The outer diameter of the head flange 425 is greater than the inner diameter of the spacer 440 and smaller than the outer diameter of the spacer 440. The outer diameter of the annular spacer 440 is smaller than the inner diameter of the body 450 of the tolerance compensation element 410 in the closed state.

As shown in FIGS. 4C and 4D, the tolerance compensation element 410 further includes at least three elastic legs 470 provided on the inner wall of the body 450. The elastic legs 470 are connected to the inner walls of the body segments 450a, 450b and extend into the channel 412. The elastic legs 470 are used to cooperate with the body portion 421 of the isolation element 420 to retain the isolation element 420 in a centered position. The elastic legs 470 are arranged in the receiving grooves 460. Each of the elastic legs 470 has a proximal end 471 connected to the inner wall of body 450 and a distal end 472 forming a free end. The distal end 472 of the elastic leg 470 is provided with an arc-shaped retaining surface 475. The arc-shaped retaining surface 475 is configured to engage with the body portion 421 of the isolation element 420. In the embodiment shown in the figures, there are four elastic legs 470, and the four elastic legs 470 are arranged symmetrically in pairs relative to the axis of the body 450.

FIGS. 5A and 5B show axial cross-sectional views of the fastening system 500 including the tolerance compensation assembly 400 with the bolt 530 being not tightened and being tightened, respectively.

As shown in FIG. 5A, when the bolt 530 is not tightened, the body 450 of the tolerance compensation element 410 is in the closed state, and the bolt 530 is not yet tightened in a nut 525. In this case, the spreading ring 430 has not applied an outward radial force to the body 450 of the tolerance compensation element 410. In the state shown in FIG. 5A, there is a gap G between the threaded connection portion 417 of the tolerance compensation element 410 and the threaded connection portion 517 of the first part 510, and the threaded connection portion 417 of the tolerance compensation element 410 do not abut against the threaded connection portion 517 of the first part 510. In the state shown in FIG. 5A, the tolerance compensation element 410 has completed the tolerance compensation in the Y direction, and the tolerance compensation element 410 abuts against the second part 520.

During the tightening of the bolt 530, the head 531 of the bolt 530 applies sufficient axial force to the head flange 425 of the isolation element 420, such that the isolation element 420 moves toward the second part 520 in the longitudinal direction Y and drives the spreading ring 430 to move toward the second part 520 relative to the tolerance compensation element 410 in the longitudinal direction Y. During this process, the spreading inclined surface 435 of the spreading ring 430 slidably engages with the mating inclined surface 485 of the tolerance compensation element 410, and the spreading ring 430 thus applies a radial force to the body 450 of the tolerance compensation element 410 to cause the two body segments 450a, 450b of the body 450 to move radially away from each other, such that the body 450 reaches the open state. The two body segments 450a, 450b of the body 450 cannot move axially relative to each other due to their threaded engagement with the first part 510. From the closed state to the open state of the body 450, the gap G between the threaded connection portion 417 of the tolerance compensation element 410 and the threaded connection portion 517 of the first part 510 is gradually eliminated, reaching the state shown in FIG. 5B.

During the fastening process of the tolerance compensation assembly, the bolt needs to be able to move in the Z and X directions to compensate for the tolerances, and the bolt is usually used in conjunction with a spacer (e.g., a separate spacer 235 shown in FIG. 3A, or a spacer integrated with the head of the bolt, or a head flange 425 shown in FIG. 5A that acts as a spacer), to increase the contact area between the head of the bolt and a part to be driven by the bolt. Therefore, when the bolt moves in the Z and X directions, the spacer also needs to move in the Z and X directions. In the tolerance compensation assembly 400 in the embodiment shown in FIGS. 4A-4D, since it is provided with a spreading means separate from the isolation element 420, and the movement of the bolt and its spacer is not performed in the isolation element, so the radial size of the tolerance compensation element 410 can be made smaller to meet the requirements of small-space use environments. Moreover, due to the provision of the annular spacer 440 arranged between the head flange 425 of the isolation element 420 and the spreading ring 430, the radial size of the tolerance compensation element 410 can be further reduced while ensuring the tolerance compensation amounts in the X and Z directions.

The inventors of the present disclosure have found that in the existing tolerance compensation fastening system, relative shaking is often easily generated between the tolerance compensation element and the first part, thereby causing abnormal noise. The inventors of the present disclosure have found that this is because, in order to make the helical movement of the tolerance compensation element relative to the first part easier, the size of the threaded connection portion (such as the helical groove) of the tolerance compensation element is often bigger than the threaded connection portion (such as the helical tooth) of the first part; however, such a configuration results in a gap between the tolerance compensation element and the threaded connection portion of the first part even in the tightened state of the bolt, and this gap results in that relative shaking is often easily generated between the tolerance compensation element and the first part. To this end, the above embodiments of the present disclosure provide various solutions to eliminate the gap described above.

Although the present disclosure is described with respect to the examples of the embodiments outlined above, various alternatives, modifications, variations, improvements, and/or substantial equivalents that are known or to be anticipated now or in the near future may be apparent to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

What is claimed is:

1. A tolerance compensation assembly (100, 400) for fastening a first part (210, 510) to a second part (220, 520) using a bolt (230, 530), comprising:
a tolerance compensation element (110, 410) comprising a body (150, 450) and having an axis (115, 415), the body (150, 450) comprising at least two body segments (150a, 150b; 450a, 450b) arranged circumferentially about the axis (115, 415), the at least two body segments (150a, 150b; 450a, 450b) together defining a channel (112, 412) extending along the axis (115, 415) and being connected to each other in a manner movable with respect to each other so as to enable the at least two body segments (150a, 150b; 450a, 450b) to come together and open with respect to each other, and the body (150, 450) further including a threaded connection portion (117, 417) provided on its outer surface for threaded connection with the first part (210, 510); and
a spreading means being inserted into the channel (112, 412) along an insertion direction and having a receiving path (122, 432) extending along the axis (115, 415) to receive the bolt (230, 530), the spreading means being configured to be able to move in the insertion direction driven by the bolt (230, 530) while the bolt (230, 530) is fastening the first part (210, 510) to the second part (220, 520), so as to apply a radial force to the at least two body segments (150a, 150b; 450a, 450b) to cause the at least two body segments (150a, 150b; 450a, 450b) to open by moving radially away from each other.

2. The tolerance compensation assembly (100, 400) of claim 1, wherein:
the spreading means comprises a spreading inclined surface (135, 435), the spreading inclined surface (135, 435) extending at an angle toward the axis (115, 415) in the insertion direction; and
the tolerance compensation element (110, 410) is provided with a mating inclined surface (185, 485) on an inner wall of the body (150, 450) thereof, and the spreading inclined surface (135, 435) slidably engages with the mating inclined surface (185, 485) to cause the at least two body segments (150a, 150b; 450a, 450b) to open by moving radially away from each other.

3. The tolerance compensation assembly (400) of claim 1, wherein:
adjacent body segments (150a, 150b; 450a, 450b) are connected to each other through elastic elements (155, 455).

4. The tolerance compensation assembly (400) of claim 2, wherein:
the spreading means comprises an annular spreading ring (430), the outer surface of the spreading ring (430) forming the spreading inclined surface (435); and
wherein the spreading inclined surface (435) slidably engages with the mating inclined surface (485) when the spreading ring (430) is driven by the bolt (530) to move in the channel (412), thereby causing the at least two body segments (450a, 450b) to move radially away from each other.

5. The tolerance compensation assembly (400) of claim 4, wherein:
the tolerance compensation element (410) is provided with a plurality of ridges (480) that are spaced apart from one another on the inner wall of the body (450) thereof, each of the ridges having an inclined ridge surface (485a), the ridge surfaces (485a) of the plurality of ridges (480) together forming the mating inclined surface (485), wherein a plurality of receiving grooves (460) is formed between adjacent ridges (480);
the spreading ring (430) further comprises a plurality of guiding ribs (437) that are spaced apart from one another on the spreading inclined surface (435), the plurality of guiding ribs (437) being respectively accommodated in the plurality of receiving grooves (460), and the guiding ribs (437) being configured to cooperate with the inner wall of the body (450) to retain the spreading inclined surface (435) in a centered position in the channel (412).

6. The tolerance compensation assembly (400) of claim 5, further comprising:
an isolation element (420) inserted into the receiving path (432) of the spreading ring (430) and configured to receive the bolt (530);
wherein the isolation element (420) is configured to isolate the tolerance compensation element (410) from an axial fastening force applied by the bolt (530).

7. The tolerance compensation assembly (400) of claim 6, further comprising:
at least three elastic legs (470) being connected to the inner wall of the body (150, 450) and extending into the channel (415);
wherein the at least three elastic legs (470) are configured to retain the isolation element (420) in a centered position in the channel (415).

8. The tolerance compensation assembly (400) of claim 7, wherein
the at least three elastic legs (470) are provided in the receiving groove (460).

9. The tolerance compensation assembly (400) of claim 8, wherein each of the elastic legs (470) has a proximal end (471) connected to the body (150, 450) and a distal end (472) forming a free end; and
wherein the distal end (472) of the elastic leg (470) is provided with an arc-shaped retaining surface (475), and the arc-shaped retaining surface (475) is configured to engage with the isolation element (420).

10. The tolerance compensation assembly (400) of claim 6, further comprising:
an annular spacer (440);
wherein the isolation element (420) comprises a head flange (425);
wherein the spacer (440) is arranged between the head flange (425) of the isolation element (420) and the spreading ring (430); and
wherein an outer diameter of the head flange (425) is greater than an inner diameter of the spacer (440) and smaller than an outer diameter of the spacer (440).

11. The tolerance compensation assembly (100) of claim 2, further comprising:
an isolation element (120) inserted into the channel (112) along the insertion direction;
wherein the spreading means is formed by the isolation element (120), the isolation element (120) forming the receiving path (122), and the outer surface of the isolation element (120) forming the spreading inclined surface (135).

12. The tolerance compensation assembly (100) of claim 11, wherein
the isolation element (120) is cylindrical, the isolation element (120) comprising an operating section (126), a connecting section (127), and an extension section (125) connected in turn in the insertion direction thereof, the connecting section (127) forming the spreading means, and the outer surface of the connecting section (127) forming the spreading inclined surface (135);
wherein the body (150) is cylindrical, the body (150) comprising a receiving section (176), a transition section (177), and a guide section (175) connected in turn in the insertion direction of the isolation element (120), and the inner wall of the transition section (177) forming the mating inclined surface (185); and
wherein when the body (150) is not opened by the spreading means, an inner diameter of the guide section (175) is smaller than an outer diameter of the operating section (126) and greater than an outer diameter of the extension section (125).

13. A fastening system (200, 500) for fastening a first part (210, 510) to a second part (220, 520), comprising:
a bolt (230, 530); and
the tolerance compensation assembly (100, 400) according to claim 1;
wherein the threaded connection portion (117, 417) on the body (150, 450) of the tolerance compensation element (110, 410) of the tolerance compensation assembly (100, 400) is threadedly connected with the first part (210, 510), and the bolt (230, 530) is inserted into the receiving path (122, 432) of the spreading means and into the second part (220, 520).
